(19) United States
(12) Patent Application Publication
(10) Pub. No.: US 2025/0183562 A1
(43) Pub. Date: Jun. 5, 2025

(54) CURRENT BAR AND CONNECTION ARRANGEMENT HAVING A CURRENT BAR OF THIS KIND

(71) Applicant: PHOENIX CONTACT GMBH & CO. KG, Blomberg (DE)

(72) Inventors: Ralph HOPPMANN, Bad Oeynhausen (DE); Martin GEBHARDT, Lage (DE); Kevin BERGHAHN, Blomberg (DE); Andre SELSE, Detmold (DE); Michael REINEKE, Steinheim (DE)

(21) Appl. No.: 18/842,828

(22) PCT Filed: Mar. 2, 2023
(86) PCT No.: PCT/EP2023/055290

§ 371 Date: Aug. 30, 2024

(30) Foreign Application Priority Data
Mar. 8, 2022 (LU) LU501611

(51) Int. Cl. H01R 4/48

(52) U.S. Cl. CPC H01R 4/4852; H01R 4/4833; H01R 4/4835

(57) ABSTRACT

A current bar for a connection arrangement for connecting an electrical conductor includes: a clamping portion, against which the electrical conductor inserted into the connection arrangement in an insertion direction is clampable. The clamping portion has a first function zone, a second function zone, and a third function zone. In an embodiment, viewed in the insertion direction, the second function zone is formed below the first function zone, and the third function zone is formed below the second function zone.

### CROSS-REFERENCE TO PRIOR APPLICATIONS

This application is a U.S. National Phase application under 35 U.S.C. § 371 of International Application No. PCT/EP2023/055290, filed on Mar. 2, 2023, and claims benefit to Luxembourg Patent Application No. LU 501611, filed on Mar. 8, 2022. The International Application was published in German on Sep. 14, 2023 as WO/2023/169918 under PCT Article 21 (2).

### FIELD

The invention relates to a current bar for a connection arrangement for connecting an electrical conductor. The invention further relates to a connection arrangement having a current bar of this kind.

### BACKGROUND

It is known that a conductor to be connected is clamped against a current bar for example by means of a clamping spring, in order to form an electrical contact with the conductor. For this purpose, the current bar usually has a clamping portion against which the conductor to be connected is clamped. The conductors to be connected can have a wide variety of configurations and properties. For example, the conductors to be connected can be rigid or flexible. Furthermore, the conductors to be connected can have a small, medium, or large conductor cross-section.

### SUMMARY

In an embodiment, the present invention provides a current bar for a connection arrangement for connecting an electrical conductor, comprising: a clamping portion, against which the electrical conductor inserted into the connection arrangement in an insertion direction is clampable, wherein the clamping portion has a first function zone, a second function zone, and a third function zone.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic representation of a current bar according to the invention;

FIG. 2 shows another schematic representation of a current bar according to the invention;

FIG. 3 shows another schematic representation of an energy distribution system according to the invention;

FIG. 4 shows another schematic representation of a current bar according to the invention;

FIG. 5 shows a schematic representation of a connection arrangement according to the invention with the clamping leg of the clamping spring in an open position;

FIG. 6 shows a schematic representation of a further connection arrangement according to the invention with the clamping leg of the clamping spring in a clamping position;

FIG. 7 shows a schematic representation of the connection arrangement shown in FIG. 5 with a connected rigid conductor having a large conductor cross-section;

FIG. 8 shows a schematic representation of the connection arrangement shown in FIG. 5 with a connected flexible conductor having a large conductor cross-section; and

FIG. 9 shows a schematic representation of the connection arrangement shown in FIG. 5 with a connected rigid conductor having a small conductor cross-section.

### DETAILED DESCRIPTION

In an embodiment, the present invention provides a current bar and a connection arrangement in which, regardless of the design of the conductor, good contact of the conductor can be ensured when clamped against the current bar.

The current bar according to the invention has a clamping portion, against which the conductor inserted into the connection arrangement in the insertion direction can be clamped, wherein the clamping portion has a first function zone, a second function zone, and a third function zone.

According to the invention, the clamping portion is no longer designed to be the same over its entire surface, but, rather, the clamping portion has different function zones. The three function zones differ from each other in terms of their design. The first function zone has a different design than the second function zone, and the third function zone has a different design than the first function zone and the second function zone. Each of the three function zones forms a functional surface or contact region for one or more types of conductors to be connected. As a result of the three differently designed function zones, different types of conductors can be connected equally well and safely. For example, the first function zone can form a contact region for rigid conductors having a large conductor cross-section. The second function zone can form a contact region for conductors having a small conductor cross-section and/or for flexible conductors. The third function zone can form a contact region for flexible conductors, which in particular have a medium or large conductor cross-section.

The three function zones preferably extend along the length of the clamping portion. Each of the three function zones preferably extends over the entire width of the clamping portion. Viewed in the insertion direction, the second function zone is preferably formed below the first function zone, and the third function zone is preferably formed below the second function zone. The second function zone is preferably arranged between the first function zone and the third function zone. Thus, viewed in the insertion direction, the three function zones are preferably arranged one behind the other. The function zones preferably border directly on one another.

The first function zone can preferably have at least one contact lug. The at least one contact lug can protrude from the surface of the clamping portion towards the conductor or conductor connection space. The at least one contact lug is preferably designed such that it can press into and/or cut into the conductor adjacent to the first function zone. The at least one contact lug is preferably designed to be sharp-edged. The at least one contact lug can allow for direct plugging and connection in particular of a rigid conductor. The first function zone can also have more than one contact lug. If two or more contact lugs are formed on the first function zone, they are preferably arranged one below the other as seen in the insertion direction.

The at least one contact lug can extend over the entire width of the clamping portion. This allows the contact lug to act upon the conductor to be connected over a larger outer circumferential surface of the conductor. Moreover, the contact lug can interact with the conductor even if the conductor is not positioned centrally across the width of the clamping portion.

The at least one contact lug can be designed in the form of an elongated contact rib, wherein the contact rib can then have a sharp or pointed edge surface over the length of the contact rib. If two or more contact lugs are provided, each contact lug can be formed by such an elongated contact rib.

The second function zone can have a flat bearing face. The bearing face is preferably designed to be smooth and without elevations. The flat bearing face allows for secure contact in particular with flexible conductors having a small conductor cross-section.

The third function zone can have a grooved contour. Due to the grooved contour, the clamping portion has an uneven surface in the region of the third function zone. The grooved contour can, for example, be designed in the form of a plurality of notches and/or grooves and/or corrugations. The grooved contour makes it possible to ensure that in particular rigid conductors having a medium conductor cross-section and/or flexible conductors having a medium or large conductor cross-section can be displaced transversely, when the clamping leg of the clamping spring impinges, in order to clamp the conductor against the clamping portion, whereby the contact quality of the clamping of the conductor against the current bar can be improved.

The grooved contour can have longitudinal grooves extending in the insertion direction and/or transverse grooves extending transversely to the insertion direction and/or transverse grooves extending diagonally to the insertion direction and/or pyramid-shaped grooves.

The three function zones can extend over differently large length portions of the clamping portion. For example, the third function zone can extend over a larger length portion than the first function zone and the second function zone.

In an embodiment, the invention provides a connection arrangement, having a housing having a conductor insertion opening, a current bar arranged in the housing, and a clamping spring arranged in the housing, which has a retaining leg and a clamping leg, wherein the clamping leg can be brought to a clamping position and to an open position. The connection arrangement furthermore has a conductor connection space, formed between a clamping portion of the current bar and the clamping leg of the clamping spring, and an actuating element by means of which the clamping leg can be brought from the clamping position to the open position. The current bar is designed and developed as described above.

Such a connection arrangement having a current bar designed and developed as described above allows for connecting a wide variety of different conductor types, wherein a good contact quality can be ensured with all types of conductors. A conductor inserted into the conductor connection space is clamped against the clamping portion of the current bar by means of the clamping leg of the clamping spring and, depending upon the design of the conductor, is thus clamped to varying degrees in the region of the individual function zones of the clamping portion of the current bar. The clamping spring is preferably designed as a leg spring, which has a retaining leg and a clamping leg designed to be pivotable relative to the retaining leg. The retaining leg is preferably arranged in a fixed position. By means of a pivoting movement of the clamping leg of the clamping spring, the clamping leg can be brought to an open position, in which the clamping leg is arranged at a distance from the current bar, and a conductor to be connected can be inserted into or guided out of the conductor connection space in an intermediate space formed thereby between the current bar and the clamping leg, and can be brought to a clamping position in which the clamping leg can bear against the current bar or against the connected conductor in order to clamp the conductor against the current bar. The clamping leg is brought in particular from the clamping position to the open position by means of an actuating element. The actuating element is movably guided in the housing, preferably purely linearly.

The connection arrangement can have a release element which is in engagement with the clamping leg of the clamping spring in the open position and which is pivotally mounted in such a way that, when the conductor to be connected is inserted into the conductor connection space in the insertion direction, the release element can be actuated in such a way that the release element comes out of engagement with the clamping leg of the clamping spring. The release element allows even a flexible conductor to be easily and safely connected and clamped against the current bar. As soon as the clamping leg has reached the open position, the clamping leg can engage with the release element so that the clamping leg is held in the open position via the release element to thus prevent an unintentional swinging back of the clamping leg from the open position to the clamping position. If the clamping leg is held in the open position by means of the release element, the actuating element can move back to its starting position against the direction of actuation, so that, in the open position of the clamping leg, there is no longer any operative connection between the actuating element and the clamping leg. As a result of a pivoting movement of the release element, the clamping leg can be disengaged from the release element in order to pivot back to the clamping position and clamp a conductor to be connected against the clamping portion of the current bar. The pivoting movement of the release element can be triggered by the conductor to be connected itself. For this purpose, the release element can have a pressure surface, against which the conductor to be connected can strike when inserted into the conductor connection space, in order to pivot the release element. For this purpose, the pressure surface can protrude into the conductor connection space. The pressure surface can limit the conductor connection space in the insertion direction of the conductor to be connected. The pressure surface is preferably flush with the conductor insertion opening of the housing.

In order to be able to hold the clamping leg in the open position, the release element can have at least one latching element with which the clamping leg can be engaged in the open position. The at least one latching element can form a kind of counter bearing for the clamping leg in the open position of the clamping leg. Preferably, the clamping leg in the region of its clamping edge latches with the at least one latching element. The latching element can, for example, be designed in the form of a latching lug against which the clamping leg can be clamped in the open position. The latching lug can preferably extend in a direction opposite to the insertion direction of the conductor. The latching lug can thus protrude from the pressure surface of the release element. Preferably, the release element has a first latching element and a second latching element. In that case, the two latching elements are preferably designed to be spaced apart from each other. The two latching elements are preferably designed to be of equal shape. The clamping leg can then latch with and be held on both latching elements in the open position.

The at least one latching element is preferably positioned such that it extends along an edge of the conductor connection space. The at least one latching element can have an inclined surface along which the conductor to be connected can be guided. Due to the inclined surface, the at least one latching element can form a kind of sliding surface into the conductor connection space in the insertion direction of the conductor to be connected. When inserting the conductor to be connected into the conductor connection space, the conductor can slide along the inclined surface so that the conductor to be connected can be prevented from getting caught at the at least one latching element when inserted into the conductor connection space.

The at least one latching element can be designed to be curved in an S-shape. The S-shaped bend can, for one, ensure that the clamping leg is securely clamped or latched into place at the at least one latching element in the open position of the clamping leg. Moreover, the S-shaped bend can at the same time form the inclined surface on which the conductor to be connected can slide.

However, the inclined surface can also be formed by a different type of angled surface, so that it does not necessarily have to be formed by a bend.

The release element is preferably formed integrally with the clamping spring. This allows the clamping spring to latch into itself when in the open position. The release element is then preferably connected to the retaining leg of the clamping spring. The retaining leg can then be arranged between the clamping leg and the release element. Preferably, the release element has a smaller width than the retaining leg, in particular in the region where the release element connects to the retaining leg, so that a good pivotable mounting of the release element on the retaining leg of the clamping spring is possible. The release element can then be pivoted relative to the retaining leg.

In order to hold the clamping spring securely in position in the housing, the clamping spring can be held on the current bar. The clamping spring can thus be attached to the current bar. Preferably, the clamping spring is held on the bottom portion of the current bar.

To hold the clamping spring on the current bar, at least one opening into which the clamping spring can engage can be formed on the current bar. The clamping spring can be immersed in the at least one opening and hook onto it in order to become attached to the current bar. For example, the clamping spring can by means of its retaining leg engage in the at least one opening. On the retaining leg, for example, a web-shaped retaining arm can be formed, which can engage in the opening on the current bar. Preferably, two such web-shaped retaining arms can be formed on the retaining leg, wherein two openings can then also be formed on the current bar so that the first web-shaped retaining arm can engage in a first opening on the current bar, and the second web-shaped retaining arm can engage in a second opening on the current bar. The two retaining arms and the two openings are preferably each arranged at a distance from each other. Between the two retaining arms, the connection region of the release element can then be formed on the retaining leg of the clamping spring.

Furthermore, in order to ensure a secure position of the clamping spring, the current bar can have a support portion on which the clamping spring can be supported. The clamping spring can preferably in the region of its retaining leg be supported on the support portion. For example, the support portion can be formed by a tab punched out of the bottom portion of the current bar and bent out of the plane of the bottom portion.

A terminal may have one or more such connection arrangements. The terminal can, for example, be a terminal block that can be snapped onto a mounting rail. Furthermore, the terminal can also be a PCB terminal, for example. Moreover, the connection arrangement can also be arranged in a plug connector, wherein one or more of the above-described designed and developed connection arrangements can be arranged in a plug connector.

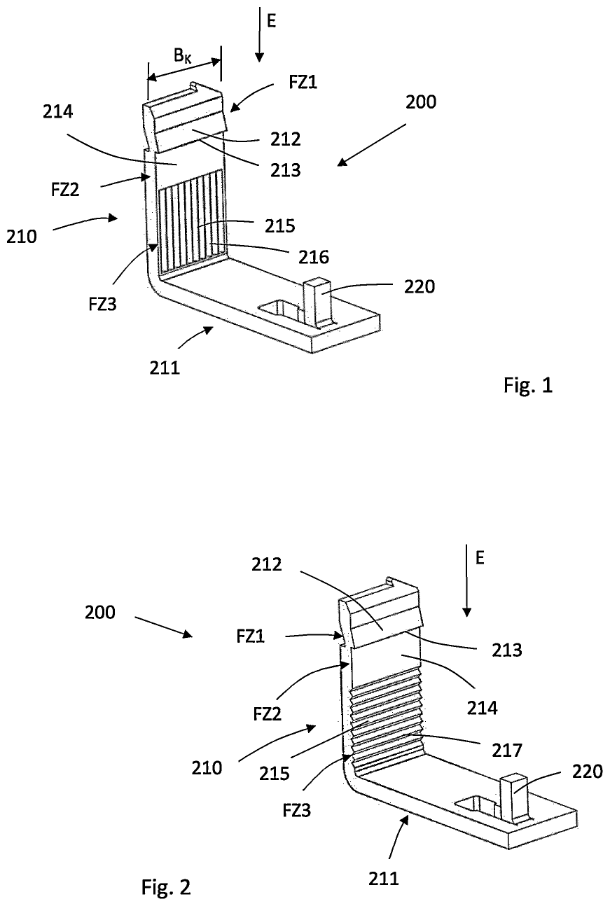

FIG. 1 shows a current bar 200, against which a conductor L to be connected can be clamped in an electrically conducting manner.

The current bar 200 has a clamping portion 210 and a bottom portion 211 extending at an angle to the clamping portion 210. In the embodiment shown here, the bottom portion 211 extends at a 90° angle to the clamping portion 210.

An electrical conductor L to be connected is clamped against the clamping portion 210. The bottom portion 211 can serve to receive and support the clamping spring 113.

The clamping portion 210 has a first function zone FZ1, a second function zone FZ2, and a third function zone FZ3. The three function zones FZ1, FZ2, FZ3 differ from each other in terms of their design and shape. Each of the three function zones FZ1, FZ2, FZ3 serves for the optimal mounting and clamping of a specific type of conductor, so that, through these three function zones FZ1, FZ2, FZ3, differently designed conductors L can be securely clamped against and thus connected to the clamping portion 210 of the current bar 200 with high contact quality, regardless of their design.

Viewed in the insertion direction E of a conductor L, the second function zone FZ2 is arranged below the first function zone FZ1, and the third function zone FZ3 is arranged below the second function zone FZ2.

In the embodiment shown here, the first function zone FZ1 has a contact lug 212. This contact lug 212 is designed in the form of an elongated contact rib, which has a sharp or pointed edge surface 212 over the length of the contact rib. With this edge surface 212, the contact lug can press and/or cut into the connected conductor L. The contact lug 212 extends over the entire width BK of the clamping portion 210. The contact lug 212 protrudes from the surface of the clamping portion 210 towards the conductor L or conductor connection space 119.

The second function zone FZ2, on the other hand, has a flat bearing face 214 which is designed to be smooth. The connected conductor L can thus lie flat against the bearing face 214 of the second function zone FZ2.

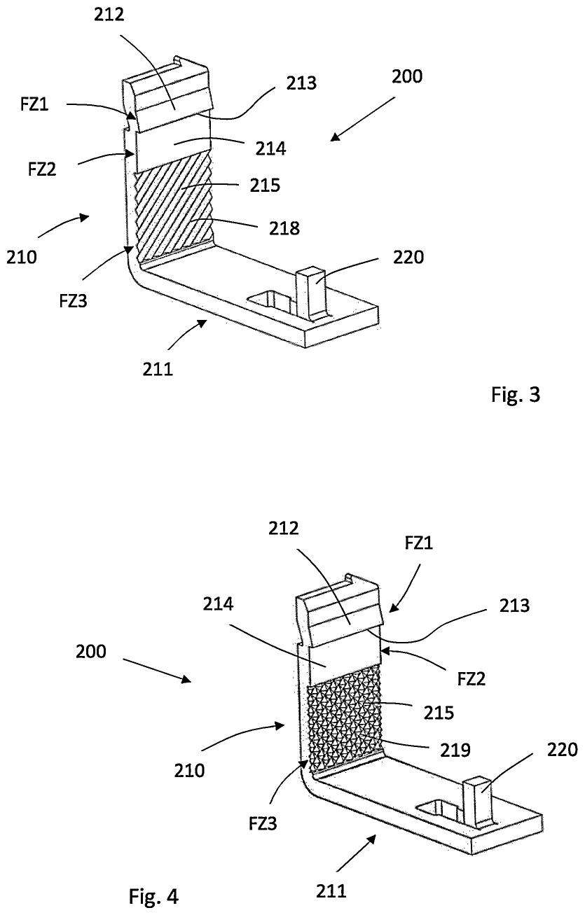

The clamping portion 210 is, however, designed to be uneven in the region of the third function zone FZ3, since the third function zone FZ3 has a grooved contour 215. The grooved contour 215 can be designed in different ways. In the embodiment shown in FIG. 1, the grooved contour 215 has longitudinal grooves 216 extending in the insertion direction E. In the embodiment shown in FIG. 2, the grooved contour 215 has transverse grooves 217 extending transversely to the insertion direction E. In the embodiment shown in FIG. 3, the grooved contour 215 has diagonal grooves 218 extending diagonally to the insertion direction E. In the embodiment shown in FIG. 4, the grooved contour 215 has pyramid-shaped grooves. In all embodiments, the grooved contour 215 extends over the entire width BK of the clamping portion 210.

The first function zone FZ1 and the second function zone FZ2 are designed to be identical in all embodiments shown in FIGS. 1 to 4.

Also, all four embodiments depicted in FIGS. 1 to 4 show that the third function zone FZ3 extends over a larger length portion of the clamping portion 210 than the first function zone FZ1 and the second function zone FZ2.

On the bottom portion 211 of the current bar 200, a support portion 220 is formed on which the clamping spring 113 can be supported, whereby the clamping spring 113 can be held in position. The clamping spring 113 can, in the region of its retaining leg 116, be supported on the support portion 220. Here, the support portion 220 is formed by a tab punched out and bent out of the bottom portion 211.

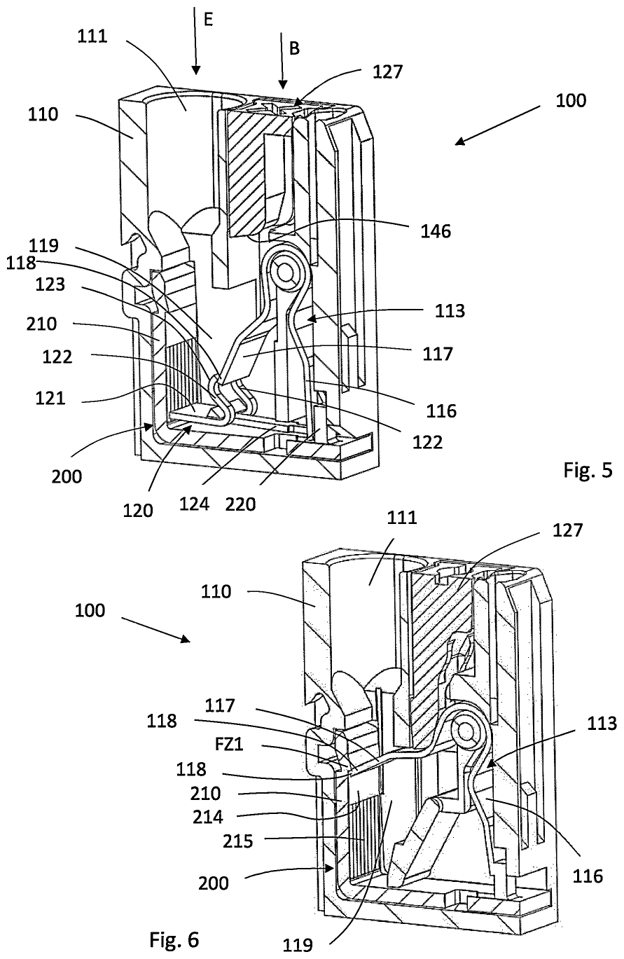

A connection arrangement 100 is shown in each of FIGS. 5 to 9. FIGS. 5, 7, 8, and 9 show a connection arrangement 100 according to one embodiment, and FIG. 6 shows another connection arrangement 100 according to another possible embodiment.

The connection arrangement 100 has a housing 110. The housing 110 can be formed from an insulating material. The housing 110 has a conductor insertion opening 111 through which a conductor L to be connected can be inserted into the housing 110 in the insertion direction E.

A current bar 200 and a clamping spring 113 are arranged in the housing 110, wherein a conductor L inserted into the housing 110 can be clamped against and thus connected to the current bar 200 by means of the clamping spring 113. In all connection arrangements 100 shown here in FIGS. 5 to 9, the current bar 200 is designed in accordance with the embodiment shown in FIG. 1.

The clamping spring 114 is designed as a leg spring. The clamping spring 114 has a retaining leg 116 and a clamping leg 117. The retaining leg 116 is arranged in a fixed position in the housing 110. The clamping leg 117 is pivotable relative to the retaining leg 116 in order to bring the clamping leg 117 to a clamping position and to an open position. The clamping leg 117 has at its free end portion a clamping edge 118, which, in the clamping position of the clamping leg 117, clamps the conductor L to be connected against the clamping portion 210 of the current bar 200.

Clamping of the conductor L is performed in a conductor connection space 119 formed in the housing 110. The conductor L to be connected can be inserted into the conductor connection space 119 via the conductor insertion opening 111. The conductor connection space 119 is formed between the clamping portion 210 of the current bar 200 and the clamping leg 117 of the clamping spring 113.

Viewed in the insertion direction E, in the connection arrangement 100 shown in FIGS. 5, 7, 8, and 9, the conductor connection space 119 is delimited towards the bottom by a release element 120. The release element 120 is pivotally mounted so that it can tilt. The release element 120 has a pressure surface 121 which faces the conductor insertion opening 111 and against which a conductor L can abut during insertion into the conductor connection space 119. When the conductor L contacts the pressure surface 121, the release element 120 pivots or tilts in the insertion direction E.

In the open position of the clamping leg 117 of the clamping spring 113, the release element 120 is in engagement with the clamping leg 117 so as to hold the clamping leg 117 in the open position, as shown, for example, in FIG. 1. Now, if a conductor L to be connected contacts the pressure surface 121 and causes a pivoting movement of the release element 120 in the insertion direction E, the clamping leg 117 comes out of engagement with the release element 120, whereby the clamping leg 117 can pivot in the direction of the conductor L in order to clamp the conductor L, inserted into the conductor connection space 119, against the clamping portion 210 of the current bar 200.

In the embodiment shown here, the release element 120 has two latching elements 122, as can be seen in FIGS. 5 to 9. The two latching elements 122 are arranged at a distance from each other. Via these two latching elements 122, the clamping leg 117 can, in the region of its clamping edge 118 when in the open position, be in engagement with the release element 120. As can be seen in particular in FIG. 5, the clamping leg 117 can in the open position hook onto the two latching elements 122 so that the clamping leg 117 can be held in the open position via the two latching elements 122.

The two latching elements 122 extend from the pressure surface 121 against the insertion direction E. The two latching elements 122 are positioned at the edge of the conductor connection space 119 so that the latching elements 122 delimit the conductor connection space 119. In order to prevent the conductor L from getting caught on the latching elements 122 when being inserted into the conductor connection space 119, the latching elements 122 each have an inclined surface 123. The inclined surfaces 123 are formed on the latching elements 122 such that the inclined surfaces 123 are directed towards the conductor connection space 119. The conductor L can slide along the inclined surfaces 123 when being inserted in the insertion direction E.

The two latching elements 122 are designed to be of equal shape. The two latching elements 122 are here each designed to be S-shaped. The two latching elements 122 are each designed in the form of a latching lug and are bent out of the plane of the pressure surface 121 of the release element 120.

The release element 120 is formed integrally with the clamping spring 113. The release element 120 is connected directly to the retaining leg 116 of the clamping spring 113. The retaining leg 116 thus extends between the release element 120 and the clamping leg 117 of the clamping spring 113.

The release element 120 is integrally formed on the retaining leg 116 of the clamping spring 113 via a connection region 124. The connection region 124 has a smaller width than the retaining leg 116. The connection region 124 also has a smaller width than the release element 120 in the region of its pressure surface 121. Due to the small width of the connection region 124, the release element 120 can have good pivotability relative to the retaining leg 116. The release element 120 is pivotally mounted on the retaining leg 116 of the clamping spring 113 via the connection region 124. The connection region 124 is designed in the form of a narrow web.

The clamping spring 113 is held on the current bar 200 via the bottom portion 211 of the current bar 200. This allows for a firm and tilt-proof mounting of the clamping spring 113 on the current bar 200.

In order to bring the clamping leg 117 from the clamping position to the open position, an actuating element 127 is mounted in the housing 110 so as to be linearly displaceable. An actuating element 127 can be displaced in an actuating direction B to bring the clamping leg 117 from the clamping position to the open position. The actuating direction B extends parallel to the insertion direction E of the conductor L and into the conductor connection space 119. In the starting position, as shown in FIGS. 5 to 9, the actuating element 127 is no longer located between the clamping leg 117 of the clamping spring 113 and the clamping portion 210 of the current bar 200. In the starting position, the actuating element 127 is positioned above the clamping spring 113. In the starting position, the actuating element 128 is positioned so far above the clamping spring 113 that the actuating surface 146 of the actuating element 127, with which the actuating element 127 presses on the clamping leg 117 when the clamping leg 117 is actuated, is also arranged above the clamping spring 113.

FIG. 5 shows the connection arrangement 100 with the clamping leg 117 of the clamping spring 113 in the open position. The clamping spring 113 is locked in itself by the clamping leg 117 in the region of its clamping edge 118 being hooked onto the two latching elements 122 of the release element 120 and thus held in a fixed position.

Hooking the clamping leg 117 onto the two latching elements 122 takes place outside the conductor connection space 119. At the sides, only the inclined surfaces 123 of the latching elements 122 protrude slightly into the conductor connection space 119, so that a conductor L can slide along the inclined surfaces 123 when being inserted into the conductor connection space 119.

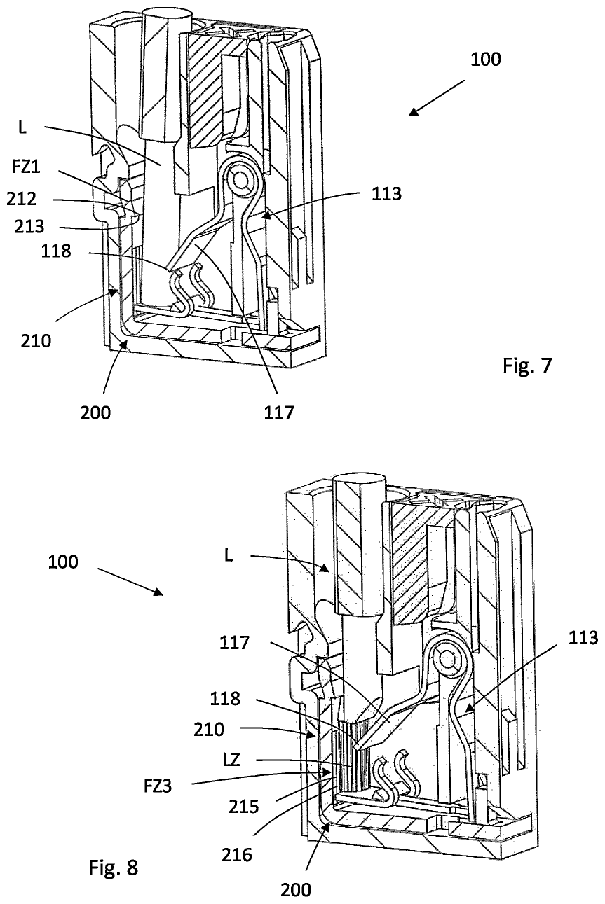

When a conductor L is inserted into the conductor connection space 119 in the insertion direction E, the conductor L contacts the pressure surface 121 of the release element 120. This causes a tilting movement of the release element 120 in the insertion direction E, whereby the latching elements 122 also tilt and are thus moved away from the clamping leg 117. As a result, the clamping leg 117 comes out of engagement with the latching elements 122, so that the clamping leg 117 can automatically pivot away from the retaining leg 116 in the direction of the conductor L in order to be able to clamp the conductor L against the clamping portion 210 of the current bar 200. This clamped position is shown in FIGS. 7 to 9.

If the conductor L is to be released again from the clamped position, the actuating element 127 is displaced in the actuating direction B. Due to the displacement movement of the actuating element 127, the actuating element 127 with its actuating surface 146 presses the clamping leg 117 away from the conductor L or from the clamping portion 210 of the current bar 200, so that the clamping leg 117 is pivoted in the direction of the retaining leg 116. The actuating element 127 applies a compressive force to the clamping leg 117 until the clamping leg 117 again comes into engagement with the release element 120 or with the latching elements 122 of the release element 120, and is thus in the open position.

FIG. 7 shows a conductor L connected to the connection arrangement 100, the conductor L being rigid and having a large conductor cross-section. The conductor L inserted into the conductor connection space 119 is clamped against the clamping portion 210 of the current bar 200 by means of the clamping leg 117 of the clamping spring 113. The conductor L is clamped in particular against the first function zone FZ1 of the clamping portion 210 in this process, so that the conductor L contacts the contact lug 212 of the first function zone FZ1.

FIG. 8 shows a conductor L connected to the connection arrangement 100, the conductor L being flexible and having a large conductor cross-section. The conductor L inserted into the conductor connection space 119 is clamped against the clamping portion 210 of the current bar 200 by means of the clamping leg 117 of the clamping spring 113. The flexible conductor L is pressed to become wider, in particular in the region of the third function zone FZ3, by means of the clamping leg 117, so that the individual strands LZ of the conductor L are pressed to become wider and are pressed into the grooved contour 215. During clamping, the strands LZ of the conductor L are displaced transversely by the clamping leg 117 and pressed into the grooved contour 215 or into the longitudinal grooves 216.

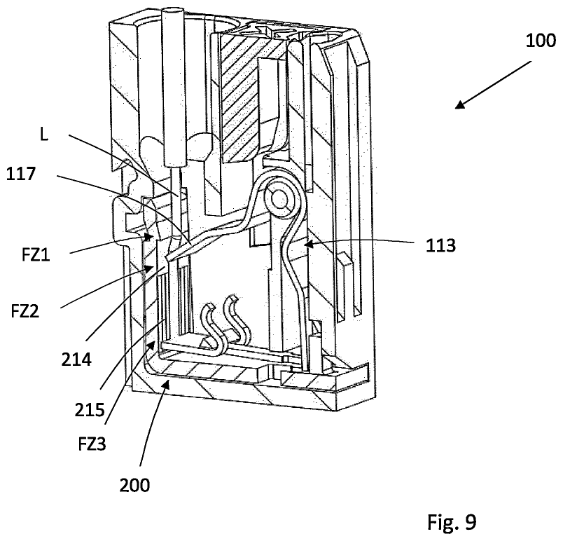

FIG. 9 shows a conductor L connected to the connection arrangement 100, the conductor L being rigid and having a small conductor cross-section. The conductor L inserted into the conductor connection space 119 is clamped against the clamping portion 210 of the current bar 200 by means of the clamping leg 117 of the clamping spring 113. In the region of the first function zone FZ1, the conductor L is pressed against the contact lug 212. The conductor L rests flat against the flat bearing face 214 of the second function zone FZ2, since the clamping leg 117 in the region of the second function zone FZ2 is clamped against the conductor L. The flat bearing face 214 can prevent the conductor L from being displaced due to its small conductor cross-section into the grooved contour 215 of the third function zone FZ3, in which case there would not be sufficient contact force to act upon the conductor L.

FIG. 6 shows a connection arrangement 100 without such a release element 120. Here, the clamping leg 117 is held in the open position by means of the actuating element 127. The current bar 200 corresponds to the current bar 200 as formed in the connection arrangement 100 shown in FIGS. 5, 7, 8, and 9.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Connection arrangement
110 Housing
111 Conductor insertion opening
113 Clamping spring
116 Retaining leg
117 Clamping leg
118 Clamping edge
119 Conductor connection space
120 Release element
121 Pressure surface
122 Latching element
123 Inclined surface
124 Connection region
127 Actuating element
146 Actuating surface
200 Current bar
210 Clamping portion
211 Bottom portion
212 Contact lug
213 Edge surface
214 Bearing face
215 Grooved contour
216 Longitudinal grooves
217 Transverse grooves
218 Diagonal grooves
219 Pyramid-shaped grooves
220 Support portion
E Insertion direction
B Actuation direction
BK Width of the clamping portion
L Conductor
LZ Strands
FZ1 First function zone
FZ2 Second function zone
FZ3 Third function zone

1. A current bar for a connection arrangement for connecting an electrical conductor, comprising:
a clamping portion, against which the electrical conductor inserted into the connection arrangement in an insertion direction is clampable,
wherein the clamping portion has a first function zone, a second function zone, and a third function zone.

2. The current bar of claim 1, wherein, viewed in the insertion direction, the second function zone is formed below the first function zone, and the third function zone is formed below the second function zone.

3. The current bar of claim 1, wherein the first function zone has at least one contact lug.

4. The current bar of claim 3, wherein the at least one contact lug extends over an entire width of the clamping portion.

5. The current bar of claim 1, wherein the second function zone has a flat bearing face.

6. The current bar of claim 1, wherein the third function zone has a grooved contour.

7. The current bar of claim 6, wherein the grooved contour has longitudinal grooves extending in the insertion direction and/or transverse grooves extending transversely to the insertion direction and/or diagonal grooves extending diagonally to the insertion direction and/or pyramid-shaped grooves.

8. The current bar of claim 1, wherein the third function zone extends over a larger length portion of the clamping portion than the first function zone and the second function zone.

9. A connection arrangement for connecting an electrical conductor (L), comprising:
a housing having a conductor insertion opening;
the current bar of claim 1 arranged in the housing;
a clamping spring arranged in the housing and having a retaining leg and a clamping leg, the clamping leg being configured to be brought to a clamping position and to an open position;
a conductor connection space formed between the clamping portion of the current bar and the clamping leg of the clamping spring; and
an actuating element by which the clamping leg is configured to be brought from the clamped position to the open position.

10. The connection arrangement of claim 9, wherein, in the housing, a release element is arranged which is in engagement with the clamping leg of the clamping spring in the open position and which is pivotally mounted such that, when the conductor to be connected is inserted into the conductor connection space in the insertion direction, the release element is actuatable such that the release element comes out of engagement with the clamping leg of the clamping spring.

11. The connection arrangement of claim 10, wherein the release element has at least one latching element with which the clamping leg is in engagement in the open position.

12. The connection arrangement of claim 10, wherein the release element is formed integrally with the clamping spring.

13. The connection arrangement of claim 9, wherein the clamping spring is held on the current bar.

14. The connection arrangement of claim 9, wherein the current bar has a support portion on which the clamping spring is supported.
